(19) United States
(12) Patent Application Publication
(10) Pub. No.: US 2025/0046098 A1
(43) Pub. Date: Feb. 6, 2025

(54) INFORMATION PROCESSING DEVICE, MOVING BODY, INFORMATION PROCESSING METHOD, AND COMPUTER-READABLE STORAGE MEDIUM

(71) Applicant: HONDA MOTOR CO.,LTD., Tokyo (JP)

(72) Inventors: Takahiro KUREHASHI, Saitama (JP); Moriya HORIUCHI, Saitama (JP); Yuta SAKAGAWA, Saitama (JP)

(21) Appl. No.: 18/744,686

(22) Filed: Jun. 16, 2024

(30) Foreign Application Priority Data
Jul. 31, 2023 (JP) 2023-124652

(51) Int. Cl. G06V 20/58; B60W 50/14; G06T 7/20

(52) U.S. Cl. CPC G06V 20/58; B60W 50/14; G06T 7/20

(57) ABSTRACT

An information processing device includes: an acquiring unit which acquires information detected by an image-capturing device provided in a moving body; a predicting unit which predicts at least one of a movement or a moving direction of a moving object which exists in a vicinity of the moving body based on the information acquired by the acquiring unit; a warning control unit which performs control to output a warning based on at least one of the movement or the moving direction of the moving object predicted by the predicting unit; and a transmission control unit which performs control to transmit information indicating at least one of the movement or the moving direction of the moving object predicted by the predicting unit to another moving body around the moving body.

The contents of the following patent application(s) are incorporated herein by reference:
NO. 2023-124652 filed in JP on Jul. 31, 2023.

### BACKGROUND

### 1. Technical Field

The present invention relates to an information processing device, a moving body, an information processing method, and a computer-readable storage medium.

### 2. Related Art

In recent years, efforts have been intensified to provide access to a sustainable transportation system with consideration given even to vulnerable people among other traffic participants. To achieve this, research and development have been focused on further improving traffic safety and convenience through research and development regarding a preventive safety technique. In Patent document 1-2, techniques to notify a hazardous event or a risk area sensed by a vehicle to another vehicle are described.

### PRIOR ART DOCUMENT

### Patent Document

Patent document 1: Japanese Patent Application Publication No. 2020-102822
Patent Document 2: Japanese Patent Application Publication No. 2023-11080

### BRIEF DESCRIPTION OF THE DRAWINGS

FIG. 1 schematically shows a usage scene of an assistance system 10.

FIG. 2 shows a system configuration of a vehicle 20.

FIG. 3 shows a processing in which an in-vehicle information processing device 40a determines whether to cause a warning to be output.

FIG. 4 shows an example flowchart for an information processing method performed by an in-vehicle information processing device 40.

FIG. 5 shows an example of a computer 2000.

### DESCRIPTION OF EXEMPLARY EMBODIMENTS

Hereinafter, embodiments of the present invention will be described. However, the following embodiments are not for limiting the invention according to the claims. In addition, not all the combinations of features described in the embodiments are essential to the solution of the invention.

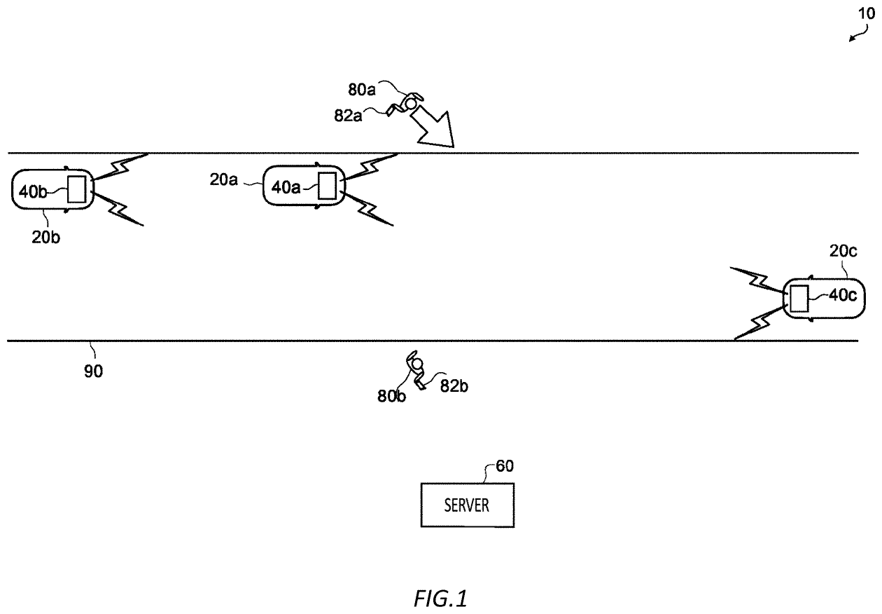

FIG. 1 schematically shows a usage scene of an assistance system 10. The assistance system 10 includes a vehicle 20a; a vehicle 20b and a vehicle 20c; a pedestrian terminal 82a and a pedestrian terminal 82b; and a server 60.

The vehicle 20a includes an in-vehicle information processing device 40a, and the vehicle 20b includes an in-vehicle information processing device 40b, and the vehicle 20c includes an in-vehicle information processing device 40c. The pedestrian terminal 82a is a terminal carried by a pedestrian 80a, and the pedestrian terminal 82b is a terminal carried by a pedestrian 80b. In the present embodiment, the pedestrian 80a and the pedestrian 80b are pedestrians. The pedestrian 80a and the pedestrian 80b are one example of a moving object.

In the present embodiment, the vehicle 20a, the vehicle 20b, and the vehicle 20c may be collectively referred to as a “vehicle(s) 20”. The in-vehicle information processing device 40a, the in-vehicle information processing device 40b, and the in-vehicle information processing device 40c may be collectively referred to as an “in-vehicle information processing device(s) 40”. The pedestrian terminal 82a and the pedestrian terminal 82b may be collectively referred to as a “pedestrian terminal(s) 82”. The pedestrian 80a and the pedestrian 80b may be collectively referred to as a “pedestrian(s) 80”.

The vehicle 20 is a vehicle traveling on a roadway 90. The vehicle 20 is one example of a moving body. The vehicle 20 is configured to include various sensors, such as a location sensor including a Global Navigation Satellite Systems (GNSS) receiver, a vehicle speed sensor, an image-capturing device, and a radar. The in-vehicle information processing device 40 processes information acquired by the various sensors which the vehicle 20 includes. The in-vehicle information processing device 40 communicates with each of an in-vehicle information processing device 40 of another vehicle 20 and the server 60. The in-vehicle information processing device 40 provides an Advanced Driver-Assistance Systems (ADAS) functionality, which the vehicle 20 includes.

The pedestrian terminal 82 is a mobile terminal, such as a smartphone. The pedestrian terminal 82 is one example of a moving body. The pedestrian terminal 82 periodically transmits, to the server 60, current location information of the pedestrian terminal 82 detected by the location sensor including the GNSS receiver.

The server 60 receives, by mobile communication, information transmitted from the in-vehicle information processing device 40 and the pedestrian terminal 82. The server 60 may receive, through mobile communication and a communication line such as the Internet and a dedicated line, information transmitted from the in-vehicle information processing device 40 and the pedestrian terminal 82.

The in-vehicle information processing device 40a determines an attitude of the pedestrian 80 by analyzing an image of the pedestrian 80 acquired by the image-capturing device which the vehicle 20 includes to extract a skeletal frame of the pedestrian 80. The in-vehicle information processing device 40a determines at least one of a movement or a moving direction of the pedestrian 80 from the skeletal frame and/or the attitude extracted from a plurality of images. The in-vehicle information processing device 40a predicts a location of the pedestrian 80 at a time point after a predetermined period from at least one of the movement or moving direction of the pedestrian 80 that is determined.

The in-vehicle information processing device 40a also predicts a location of the vehicle 20 at the time point after the predetermined period. When a distance between the predicted location of the pedestrian 80 and a location of the vehicle 20a is shorter than a predetermined threshold, the in-vehicle information processing device 40a determines that the pedestrian 80 and the vehicle 20a will approach each other and causes a warning to be output to an occupant of the vehicle 20a. When the in-vehicle information processing device 40a determines that the pedestrian 80 and the vehicle 20a will approach each other, the in-vehicle information processing device 40a may cause the warning to be output to the pedestrian terminal 82 by direct communication or via the server 60.

On the other hand, when the in-vehicle information processing device 40a determines that the pedestrian 80 and the vehicle 20a will not approach each other within the predetermined period, the in-vehicle information processing device 40a does not cause the warning to be output to either the occupant of the vehicle 20a or the pedestrian terminal 82. For example, when the vehicle 20a has already passed through the location of the pedestrian 80a before the pedestrian 80a reaches a travel path of the vehicle 20a, the in-vehicle information processing device 40a does not cause the warning to be output. Even in such a case, the in-vehicle information processing device 40a transmits information indicating the movement and/or moving direction of the pedestrian 80 that is determined to the vehicle 20b and the vehicle 20c around it by direct communication or via the server 60.

The in-vehicle information processing device 40b of the vehicle 20b and the in-vehicle information processing device 40c of the vehicle 20c utilize the information indicating the movement and/or the moving direction of the pedestrian 80 received from the in-vehicle information processing device 40a to perform assistance such as outputting a warning to occupants of the vehicle 20b and the vehicle 20c. Because the vehicle 20a is located closer to the pedestrian 80 than the vehicle 20b and the vehicle 20c, the in-vehicle information processing device 40a can determine the movement and/or the moving direction of the pedestrian 80 more accurately than the in-vehicle information processing device 40b and the in-vehicle information processing device 40c can determine the movement and/or the moving direction of the pedestrian 80.

According to the assistance system 10, the in-vehicle information processing device 40b of the vehicle 20b that travels behind the vehicle 20a is allowed to utilize at an earlier timing a movement and/or a moving direction of the pedestrian 80a that is determined at a location closer to the pedestrian 80a than a location of the vehicle 20b. Similarly, the in-vehicle information processing device 40c of the vehicle 20c that travels on an opposite lane to the vehicle 20a is allowed to utilize at an earlier timing a movement and/or a moving direction of the pedestrian 80b that is determined at a location closer to the pedestrian 80b than a location of the vehicle 20c. Therefore, the assistance system 10 allows traffic participants to assist more accurately.

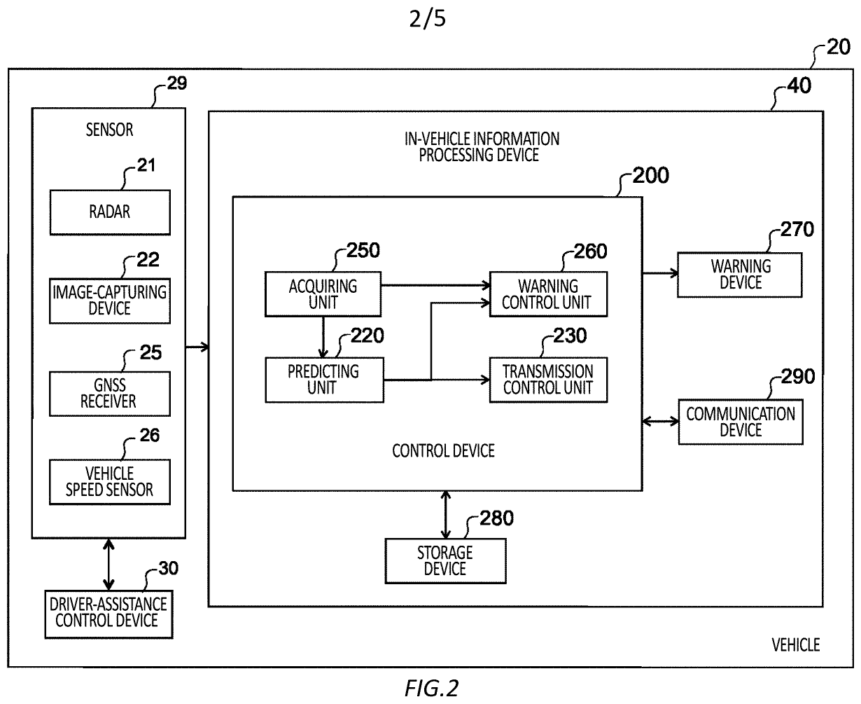

FIG. 2 shows a system configuration of the vehicle 20. The vehicle 20 includes a sensor 29, a driver-assistance control device 30, a warning device 270, and a communication device 290.

The sensor 29 includes a radar 21, an image-capturing device 22, a GNSS receiver 25, and a vehicle speed sensor 26. The radar 21 may be a LiDAR, a millimeter wave radar, or the like. The GNSS receiver 25 receives a radio wave transmitted from a GNSS satellite. The GNSS receiver 25 generates information indicating a current location of the vehicle 20 based on a signal received from the GNSS satellite. The image-capturing device 22 captures surroundings of the vehicle 20 to generate image information. For example, the image-capturing device 22 captures spaces in a direction of travel of the vehicle 20 and a direction opposite to the direction of travel to generate image information. The vehicle speed sensor 26 detects a vehicle speed of the vehicle 20. The sensor 29 may further include a location sensor such as an odometer, an inertial measurement unit (IMU) such as an acceleration sensor, an attitude sensor, and the like.

The driver-assistance control device 30 uses the information detected by the sensor 29 to assist driving the vehicle 20. The driver-assistance control device 30 may be implemented by an Electronic Control Unit (ECU) with an ADAS functionality.

The warning device 270 includes a Human Machine Interface (HMI) functionality, for example. The warning device 270 outputs a warning to an occupant of the vehicle 20 via the HMI functionality.

The communication device 290 is responsible for communication with an outside of the vehicle 20. The communication device 290 performs vehicle-to-vehicle communication by direct communication, such as the PC5. The communication device 290 may communicate with another vehicle 20 via a communication through a base station for mobile communication. The communication device 290 may communicate directly with the pedestrian terminal 82.

The in-vehicle information processing device 40 includes a control device 200, a storage device 280, and the communication device 290. The control device 200 is implemented by an arithmetic processing unit including a processor, for example. The storage device 280 is implemented with a non-volatile storage medium included in it. The control device 200 performs processing using information stored in the storage device 280. The control device 200 may be implemented by an ECU including a microcomputer which includes a CPU, a ROM, a RAM, an I/O, a bus, and the like.

The communication device 290 is responsible for communication between each of the in-vehicle information processing device 40 and the pedestrian terminal 82, and the server 60, based on control by the control device 200.

The control device 200 includes an acquiring unit 250, a predicting unit 220, a transmission control unit 230, and a warning control unit 260. Note that a form may be employed in which the in-vehicle information processing device 40 does not include a part of functionalities of a functional configuration of the in-vehicle information processing device 40 shown in FIG. 2. A form may be employed in which the sensor 29 includes a part of functionalities that the in-vehicle information processing device 40 includes.

The acquiring unit 250 acquires information detected by the sensor 29 provided in the vehicle 20. The predicting unit 220 predicts at least one of a movement or a moving direction of the pedestrian 80 that exists in a vicinity of the vehicle 20 based on the information acquired by the acquiring unit 250. The warning control unit 260 performs control to output a warning based on at least one of the movement or the moving direction of the pedestrian 80 predicted by the predicting unit 220. The warning control unit 260 causes the warning device 270 to output the warning to an occupant of the vehicle 20. The transmission control unit 230 performs control to transmit information indicating at least one of the movement or the moving direction of the pedestrian 80 predicted by the predicting unit 220 to another vehicle 20 around the vehicle 20. This allows for sharing with the another vehicle 20 at least one of the movement or the moving direction of the pedestrian 80 that is determined by the vehicle 20.

As an example, the acquiring unit 250 may acquire an image captured by the image-capturing device 22, and the predicting unit 220 may determine an attitude of the pedestrian 80 based on the image acquired by the acquiring unit 250, and predict at least one of a movement or a moving direction of the pedestrian 80 based on an attitude of the pedestrian 80 that is determined. This allows for sharing with the another vehicle 20 at least one of the movement or the moving direction predicted based on the attitude of the pedestrian 80.

The acquiring unit 250 may acquire an image captured by the image-capturing device 22, and the predicting unit 220 may determine an attitude of the pedestrian 80 based on the image acquired by the acquiring unit 250 and predict as a movement of the pedestrian 80 whether the pedestrian 80 will move toward a path of the vehicle 20 based on an attitude of the pedestrian 80 that is determined. This allows for sharing with the another vehicle 20 “whether the pedestrian 80 will move toward the path of the vehicle 20”.

The predicting unit 220 predicts a movement velocity of the pedestrian 80 based on the information acquired by the acquiring unit 250. This allows for sharing with the another vehicle 20 the movement velocity of the pedestrian 80.

The warning control unit 260 performs control to output a warning to an occupant of the vehicle 20 when it is determined that the pedestrian 80 will get into the path of the vehicle 20 before the vehicle 20 reaches the location of the pedestrian 80 in the direction of travel of the vehicle 20 based on the movement velocity of the pedestrian 80 predicted by the predicting unit 220. The transmission control unit 230 performs control to transmit to the surroundings of the vehicle 20 information indicating at least one of the movement or the movement velocity of the pedestrian 80 predicted by the predicting unit 220 even when the warning control unit 260 determines that the pedestrian 80 will not get into the path of the vehicle 20 before the vehicle 20 reaches the location of the pedestrian 80 in the direction of travel of the vehicle 20.

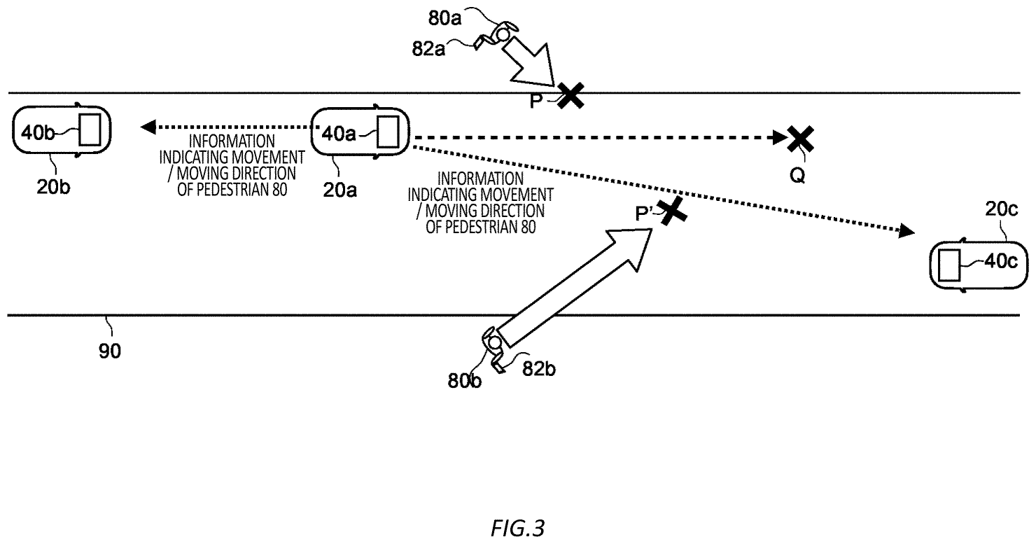

FIG. 3 shows a processing in which the in-vehicle information processing device 40a determines whether to cause a warning to be output. The predicting unit 220 determines an attitude of the pedestrian 80a by extracting a skeletal frame of the pedestrian 80a from an image captured by the image-capturing device 22. The in-vehicle information processing device 40a predicts a movement of the pedestrian 80a from the skeletal frame and/or the attitude of the pedestrian 80a obtained from one or more images, or a change in the skeletal frame and/or the attitude of the pedestrian 80a.

The predicting unit 220 may predict a moving direction of the pedestrian 80a based on the current attitude and/or the change in the attitude of the pedestrian 80a that is determined, instead of or in addition to on the movement of the pedestrian 80a. The predicting unit 220 may determine a speed at which the pedestrian 80a moves, based on the current attitude and/or skeletal frame and/or the change in the attitude and/or the skeletal frame of the pedestrian 80a.

The predicting unit 220 may determine the speed at which the pedestrian 80a moves by determining whether the attitude of the pedestrian 80a is a running attitude or a walking attitude. The predicting unit 220 may determine a speed of leg movement of the pedestrian 80a from the change in the skeletal frame of the pedestrian 80a, and determine a speed at which the pedestrian 80a moves considering the speed of the leg movement that is determined. The predicting unit 220 may determine a length of a leg of the pedestrian 80a from the skeletal frame of the pedestrian 80a, and determine the speed at which the pedestrian 80a moves considering the length of the leg that is determined. The predicting unit 220 may determine the length of the leg of the pedestrian 80a also considering a distance from the vehicle 20a to the pedestrian 80a acquired by the radar 21. The predicting unit 220 may predict the movement velocity of the pedestrian 80a based on the moving direction and the speed at which the pedestrian 80a moves.

The predicting unit 220 may determine an age range to which the pedestrian 80a belongs from the image captured by the image-capturing device 22. The predicting unit 220 may predict a range where the pedestrian 80a may move within a predetermined period in the future, considering the age range to which the pedestrian 80a belongs. For example, when the age range to which the pedestrian 80a belongs is equal to a predetermined age range or higher, the predicting unit 220 may make narrower the range where the pedestrian 80a may move within the predetermined period with a higher age range to which the pedestrian 80a belongs.

As shown in FIG. 3, when the movement velocity of the pedestrian 80a is determined, the predicting unit 220 predicts a location P of the pedestrian 80a and a location Q of the vehicle 20a at a time point after a predetermined period from a current clock time based on the movement velocity of the pedestrian 80a. When the location P exists in a predetermined range of the location Q, the warning control unit 260 determines that the vehicle 20a and the pedestrian 80a will approach each other within the predetermined period, causing the warning device 270 to output a warning.

In the example of FIG. 3, when the pedestrian 80a reaches the location P in the future, the vehicle 20a will exist at the location Q which will be ahead of the location P of the pedestrian 80a in the direction of travel of the vehicle 20a. That is, when the pedestrian 80a reaches the location P, the vehicle 20a will have passed the location P of the pedestrian 80a. Therefore, the warning control unit 260 will not cause the warning device 270 to output the warning.

However, even though the in-vehicle information processing device 40a can determine that the pedestrian 80a will not approach the vehicle 20a, it cannot determine a possibility that the pedestrian 80a will approach the vehicle 20b or the vehicle 20c in the future. Therefore, even when the warning device 270 does not output the warning, the transmission control unit 230 transmits the information indicating the movement and/or the moving direction of the pedestrian 80a predicted by the predicting unit 220 to the in-vehicle information processing device 40b and the in-vehicle information processing device 40c.

By performing a similar processing for the pedestrian 80b, the predicting unit 220 predicts a movement and/or a moving direction of the pedestrian 80b, and the warning control unit 260 determines whether to output a warning based on the predicted movement and/or moving direction of the pedestrian 80b. Therefore, even when the warning device 270 does not output the warning, the transmission control unit 230 transmits the information indicating the movement and/or the moving direction of the pedestrian 80b predicted by the predicting unit 220 to the in-vehicle information processing device 40b and the in-vehicle information processing device 40c.

The transmission of information from the in-vehicle information processing device 40a to the in-vehicle information processing device 40b and the in-vehicle information processing device 40c is performed by direct communication or communication via the server 60. The in-vehicle information processing device 40b and the in-vehicle information processing device 40c use the information indicating the movement and/or the moving direction of the pedestrian 80 predicted by the in-vehicle information processing device 40a to determine whether to output a warning to an occupant of each vehicle 20. This allows the in-vehicle information processing device 40b and the in-vehicle information processing device 40c to perform a processing for warning at an earlier timing based on information indicating a more accurate movement and/or moving direction of the pedestrian 80.

The information indicating the movement and/or the moving direction of the pedestrian 80 transmitted from the in-vehicle information processing device 40a to the in-vehicle information processing device 40b and the in-vehicle information processing device 40c may include any combination of the information indicating the moving direction of the pedestrian 80, the information indicating the movement velocity of the pedestrian 80, and the information indicating whether the pedestrian 80 will move toward the roadway 90. Note that when the attitude of the pedestrian 80 itself may indicate the movement and/or the moving direction of the pedestrian 80, the information indicating the movement and/or the moving direction of the pedestrian 80 transmitted to the in-vehicle information processing device 40b and the in-vehicle information processing device 40c may be the information indicating the attitude of the pedestrian 80 itself.

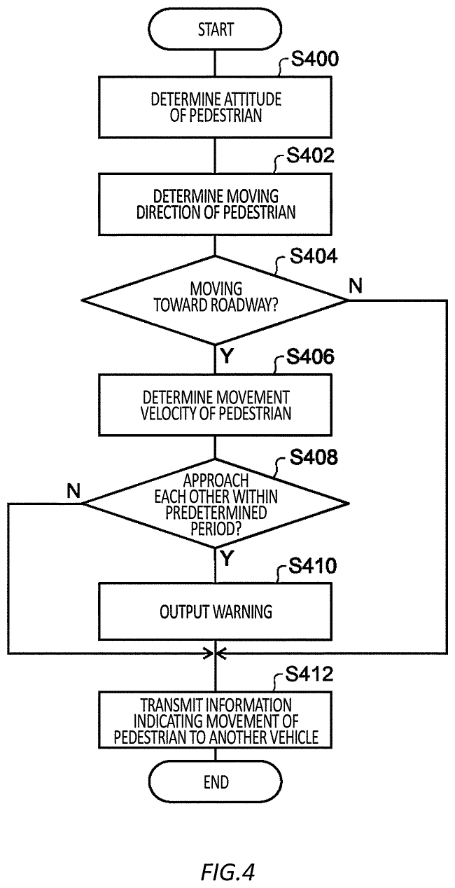

FIG. 4 shows an example flowchart relating to an information processing method performed by the in-vehicle information processing device 40.

In S400, the predicting unit 220 determines an attitude of a pedestrian based on an image acquired by the acquiring unit 250. In S402, the predicting unit 220 determines a moving direction of the pedestrian. In S404, the predicting unit 220 determines whether the pedestrian is moving toward the roadway 90 based on the moving direction. When it is determined that the pedestrian is not moving toward the roadway 90, the process proceeds to S412.

When it is determined that the pedestrian is moving toward the roadway 90, in S406, the predicting unit 220 determines a movement velocity of the pedestrian. In S408, the warning control unit 260 determines whether the pedestrian and the vehicle 20a will approach each other within a predetermined period. When it is determined that the pedestrian and the vehicle 20a will not approach each other within the predetermined period, the process proceeds to S412. When it is determined that the pedestrian and the vehicle 20a will approach each other within the predetermined period, in S410, the warning control unit 260 causes the warning device 270 to output a warning.

In S412, the transmission control unit 230 transmits information indicating the movement and/or the moving direction of the pedestrian predicted by the predicting unit 220 to the in-vehicle information processing device 40 of another vehicle 20.

In the description above, an example case is described where the acquiring unit 250 acquires an image obtained by capturing a space ahead of the vehicle 20. However, the acquiring unit 250 may acquire an image obtained by capturing a space behind the vehicle 20.

In the description above, a pedestrian is given as an example of a moving object, but the moving object is not limited to the pedestrian. The moving object may include a running person. The moving object may include a person riding on a two-wheeler, such as a bicycle (including a coaxial two-wheeler). The moving object may be an animal other than a human.

The assistance system 10 described above allows for transmitting the information indicating the movement and/or the moving direction of the pedestrian 80 in a vicinity of the vehicle 20 detected by the vehicle 20 to another vehicle 20 traveling behind or on the opposite lane. Therefore, the another vehicle 20 is allowed to acquire at an earlier timing accurate information regarding the movement and/or the moving direction. This allows for providing more accurate traffic assistance.

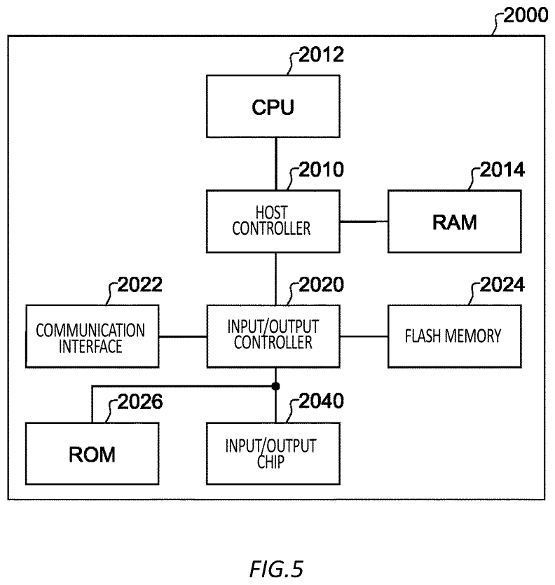

FIG. 5 shows an example of a computer 2000 in which a plurality of embodiments of the present invention can be embodied entirely or partially. A program installed on the computer 2000 can cause the computer 2000 to serve as a device such as the in-vehicle information processing device 40 according to an embodiment or each unit of said device, execute operations associated with said device or each unit of said device, and/or execute a process according to an embodiment or the steps of said process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a computer-readable storage medium such as a CD-ROM, a DVD-ROM, or a memory card, or a network. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. A device or a method may be achieved by executing operations or processing of information through using the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgment, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each of which has an attribute value of a first attribute associated with an attribute value of a second attribute, are stored in the recording medium, the CPU 2012 may retrieve an entry having a designated attribute value of the first attribute that matches a condition from said multiple entries, and read the attribute value of the second attribute stored in said entry, thereby obtaining the attribute value of the second attribute associated with the first attribute that satisfies a predetermined condition.

The programs or software units described above may be stored in the computer-readable storage medium on the computer 2000 or in a vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

The program which is installed on the computer 2000 and causes the computer 2000 to serve as the server 60 may instruct the CPU 2012 or the like to cause the computer 2000 to serve as each unit of the in-vehicle information processing device 40 (for example, the control device 200). When read by the computer 2000, the information processings written in these programs serve as each unit of the in-vehicle information processing device 40, which is a specific means where software and various hardware resources described above cooperate. These specific means implement operations or processings of information according to the intended use of the computer 2000 in the present embodiment, so that the specific in-vehicle information processing device 40 according to the intended use is constructed.

Various embodiments have been described with reference to the block diagrams and the like. In the block diagrams, each block may represent (1) a stage of a process in which an operation is executed, or (2) each unit of the device having a role in executing the operation. A specific stage and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein constitutes at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine-dependent instruction, a microcode, a firmware instruction, state-setting data, or either source code or object code written in any combination of one or more programming languages including an object-oriented programming language such as Smalltalk (registered trademark), JAVA (registered trademark), and C++, and a conventional procedural programming language such as a “C” programming language or a similar programming language.

Computer-readable instructions may be provided to a processor of a general-purpose computer, a special-purpose computer, or another programmable data processing device, or to a programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described above by using the embodiments, the technical scope of the present invention is not limited to the scope of the above-described embodiments. It is apparent to persons skilled in the art that various alterations or improvements can be made to the above-described embodiments. It is also apparent from the description of the claims that the forms to which such alterations or improvements are made can be included in the technical scope of the present invention.

Each process of the operations, the procedures, the steps, the stages etc. performed by a device, a system, a program, and a method shown in the claims, the specification, or the drawings can be executed in any order as long as the order is not indicated by “before,” “prior to,” or the like and as long as the output from a previous process is not used in a later process. Even if the operation flow is described using phrases such as “first” or “next” for the sake of convenience in the claims, the specification, or the drawings, it does not necessarily mean that the process must be performed in this order.

### EXPLANATION OF REFERENCES

10: assistance system;
20: vehicle;
21: radar;
22: image-capturing device;
25: GNSS receiver;
26: vehicle speed sensor;
29: sensor;
30: driver-assistance control device;
40: in-vehicle information processing device;
60: server;
80: pedestrian;
82: pedestrian terminal;
90: roadway;
200: control device;
220: predicting unit;
230: transmission control unit;
250: acquiring unit;
260: warning control unit;
270: warning device;
280: storage device;
290: communication device;
2000: computer;
2010: host controller;
2012: CPU;
2014: RAM;
2020: input/output controller;
2022: communication interface;
2024: flash memory;
2026: ROM;
2040: input/output chip.

What is claimed is:

1. An information processing device comprising:
an acquiring unit which acquires information detected by an image-capturing device provided in a moving body;
a predicting unit which predicts at least one of a movement or a moving direction of a moving object which exists in a vicinity of the moving body based on the information acquired by the acquiring unit;
a warning control unit which performs control to output a warning based on at least one of the movement or the moving direction of the moving object predicted by the predicting unit; and
a transmission control unit which performs control to transmit information indicating at least one of the movement or the moving direction of the moving object predicted by the predicting unit to another moving body around the moving body.

2. The information processing device according to claim 1, wherein
the acquiring unit acquires an image captured by the image-capturing device; and
the predicting unit determines an attitude of the moving object based on the image acquired by the acquiring unit and predicts at least one of the movement or the moving direction of the moving object based on the attitude of the moving object that is determined.

3. The information processing device according to claim 1, wherein
the acquiring unit acquires the image captured by the image-capturing device,
the predicting unit determines an attitude of the moving object based on the image acquired by the acquiring unit and predicts as the movement of the moving object whether the moving object will move toward a path of the moving body based on the attitude of the moving object that is determined.

4. The information processing device according to claim 1, wherein
the predicting unit predicts a movement velocity of the moving object based on the information acquired by the acquiring unit.

5. The information processing device according to claim 4, wherein
the warning control unit performs control to output the warning to an occupant of the moving body when it is determined, based on the movement velocity of the moving object predicted by the predicting unit, that the moving object will get into a path of the moving body before the moving body reaches a location of the moving object in a direction of travel of the moving body.

6. The information processing device according to claim 5, wherein
the transmission control unit performs control to transmit to surroundings of the moving body information indicating at least one of the movement or the moving direction of the moving object predicted by the predicting unit, even when the warning control unit determines that the moving object will not get into the path of the moving body before the moving body reaches the location of the moving object in the direction of travel of the moving body.

7. The information processing device according to claim 2, wherein
the predicting unit determines the attitude of the moving object based on the image acquired by the acquiring unit and predicts as the movement of the moving object whether the moving object will move toward a path of the moving body based on the attitude of the moving object that is determined.

8. The information processing device according to claim 2, wherein
the predicting unit predicts a movement velocity of the moving object based on the information acquired by the acquiring unit.

9. The information processing device according to claim 3, wherein
the predicting unit predicts a movement velocity of the moving object based on the information acquired by the acquiring unit.

10. The information processing device according to claim 7, wherein
the predicting unit predicts a movement velocity of the moving object based on the information acquired by the acquiring unit.

11. The information processing device according to claim 8, wherein
the warning control unit performs control to output the warning to an occupant of the moving body when it is determined that the moving object will get into a path of the moving body before the moving body reaches a location of the moving object in a direction of travel of the moving body based on the movement velocity of the moving object predicted by the predicting unit.

12. The information processing device according to claim 9, wherein
the warning control unit performs control to output the warning to an occupant of the moving body when it is determined that the moving object will get into the path of the moving body before the moving body reaches a location of the moving object in a direction of travel of the moving body based on the movement velocity of the moving object predicted by the predicting unit.

13. The information processing device according to claim 10, wherein
the warning control unit performs control to output the warning to an occupant of the moving body when it is determined that the moving object will get into the path of the moving body before the moving body reaches a location of the moving object in a direction of travel of the moving body based on the movement velocity of the moving object predicted by the predicting unit.

14. The information processing device according to claim 11, wherein
the transmission control unit performs control to transmit to surroundings of the moving body information indicating at least one of the movement or the moving direction of the moving object predicted by the predicting unit, even when the warning control unit determines that the moving object will not get into the path of the moving body before the moving body reaches the location of the moving object in the direction of travel of the moving body.

15. The information processing device according to claim 12, wherein
the transmission control unit performs control to transmit to surroundings of the moving body information indicating at least one of the movement or the moving direction of the moving object predicted by the predicting unit, even when the warning control unit determines that the moving object will not get into the path of the moving body before the moving body reaches the location of the moving object in the direction of travel of the moving body.

16. The information processing device according to claim 1, wherein
the moving body is a vehicle.

17. A moving body comprising the information processing device according to claim 1.

18. A moving body comprising the information processing device according to claim 16.

19. An information processing method comprising:
acquiring information detected by an image-capturing device provided in a moving body;
predicting at least one of a movement or a moving direction of a moving object which exists in a vicinity of the moving body based on the information detected by the image-capturing device;
performing control to output a warning based on at least one of the movement or the moving direction of the moving object predicted in the predicting; and
performing control to transmit information indicating at least one of the movement or the moving direction of the moving object predicted in the predicting to another moving body around the moving body.

20. A non-transitory computer-readable storage medium having stored a program which causes a computer to function as:
an acquiring unit which acquires information detected by an image-capturing device provided in a moving body;
a predicting unit which predicts at least one of a movement or a moving direction of a moving object which exists in a vicinity of the moving body based on the information acquired by the acquiring unit;
a warning control unit which performs control to output a warning based on at least one of the movement or the moving direction of the moving object predicted by the predicting unit; and
a transmission control unit which performs control to transmit information indicating at least one of the movement or the moving direction of the moving object predicted by the predicting unit to another moving body around the moving body.
